(19) United States
(12) Patent Application Publication
(10) Pub. No.: US 2006/0085143 A1
(43) Pub. Date: Apr. 20, 2006

(54) Systems and methods for robust representation of ternary data states

(76) Inventors: Kerfegar K. Katrak, Fenton, MI (US); Paul A. Bauerle, Fenton, MI (US)

Correspondence Address: CHRISTOPHER DEVRIES;General Motors Corporation, Legal Staff, Mail Code 482-C23-B21, P.O.Box 300, Detroit, MI, 48265-3000, US

(21) Appl. No.: 10/965,500

(22) Filed: Oct. 14, 2004

(51) Int. Cl. G01B 5/28

(52) U.S. Cl. 702/36

(57) ABSTRACT

Systems, methods and devices are described for robustly determining a desired operating state of a controlled device in response to the position of a multi-position actuator. Two or more ternary switch contacts provide input signals representative of the position of the actuator. Control logic then determines the desired state for the controlled device based upon the input signals received. The desired operating state is determined from any number of operating states defined by the ternary input values. Robustness is provided by selecting each of the operating states such that transitions between any operating states to another result from changes in each of the first and second ternary input values.

### TECHNICAL FIELD

The present invention generally relates to multi-state switching logic, and more particularly relates to methods, systems and devices for representing multi-state data.

### BACKGROUND

Modern vehicles contain numerous electronic and electrical switches. Vehicle features such as climate controls, audio system controls other electrical systems and the like are now activated, deactivated and adjusted in response to electrical signals generated by various switches in response to driver/passenger inputs, sensor readings and the like. These electrical control signals are typically relayed from the switch to the controlled devices via copper wires or other electrical conductors. Presently, many control applications use a single wire to indicate two discrete states (e.g. ON/OFF, TRUE/FALSE, HIGH/LOW, etc.) using a high or low voltage transmitted on the wire.

To implement more than two states, typically additional control signals are used. In a conventional two/four wheel drive transfer control, for example, four active states of the control (e.g. 2WD mode, auto 4WD mode, 4WD LO mode and 4WD HI mode) as well as a default mode are represented using three to five discrete two-state switches coupled to a single or dual-axis control lever. As the lever is actuated, the various switches identify the position of the lever to place the vehicle in the desired mode. Power take-off (PTO) controls also typically contain three or more discrete switches to represent the various states of the PTO device, which is commonly used to power upfitter-installed accessories such as bucket lifts, snow plows, lift dump bodies and the like. Numerous other multi-state switches use multiple discrete switches to represent the various positions of a single or dual-axis control mechanism, which in turn represent the various states of a controlled device.

As consumers demand additional electronic features in newer vehicles, the amount of wiring present in the vehicle continues to increase. This additional wiring occupies valuable vehicle space, adds undesirable weight to the vehicle and increases the manufacturing complexity of the vehicle. There is therefore an ongoing need in vehicle applications to reduce the amount of wiring in the vehicle without sacrificing features. Further, there is a need to increase the number of features in the vehicle without adding weight, volume or complexity commonly associated with additional wiring, and without sacrificing safety.

In particular, it is desirable to formulate multi-state switching devices for multi-state vehicle components and other components that reduce the cost, complexity and weight associated with multiple input switches, wires and other components without sacrificing safety or robustness. Furthermore, other desirable features and characteristics will become apparent from the subsequent detailed description and the appended claims, taken in conjunction with the accompanying drawings and the foregoing technical field and background.

### BRIEF SUMMARY

Systems, methods and devices are described for robustly determining a desired operating state of a controlled device in response to the position of a multi-position actuator. Two or more ternary switch contacts provide input signals representative of the position of the actuator. Control logic then determines the desired state for the controlled device based upon the input signals received. The desired operating state is determined from any number of operating states defined by the ternary input values. Robustness is provided by selecting each of the operating states such that transitions between any operating states to another result from changes in each of the first and second ternary input values.

### BRIEF DESCRIPTION OF THE DRAWINGS

The present invention will hereinafter be described in conjunction with the following drawing figures, wherein like numerals denote like elements, and:

FIG. 1 is a block diagram of an exemplary vehicle;

FIG. 2 is a circuit diagram of an exemplary embodiment of a switching circuit;

FIG. 3 is a circuit diagram of an alternate exemplary embodiment of a switching circuit;

FIG. 4 is a diagram of an exemplary switching system for processing input signals from multiple switches;

FIG. 5 is a logic diagram for an exemplary decoder module;

FIG. 6 is a set of state tables showing various robust states of a two-input ternary switch;

FIG. 7 is a set of state tables shown various robust states of a three-input ternary switch; and

FIG. 8 is an exemplary state table showing nine robust states of a three-input ternary switch.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

According to various exemplary embodiments, single and/or multi-axis controls for use in vehicles and elsewhere may be formulated with ternary switches to reduce the complexity of the control. Such switches may be used to implement robust and/or non-robust selection schemes for various types of control mechanisms, including those used for power mirrors, 2WD/4WD selectors, power take off controls and the like. Further, by selecting certain data combinations to represent the operating states of the controlled device, the robustness of the system can be preserved, or even improved.

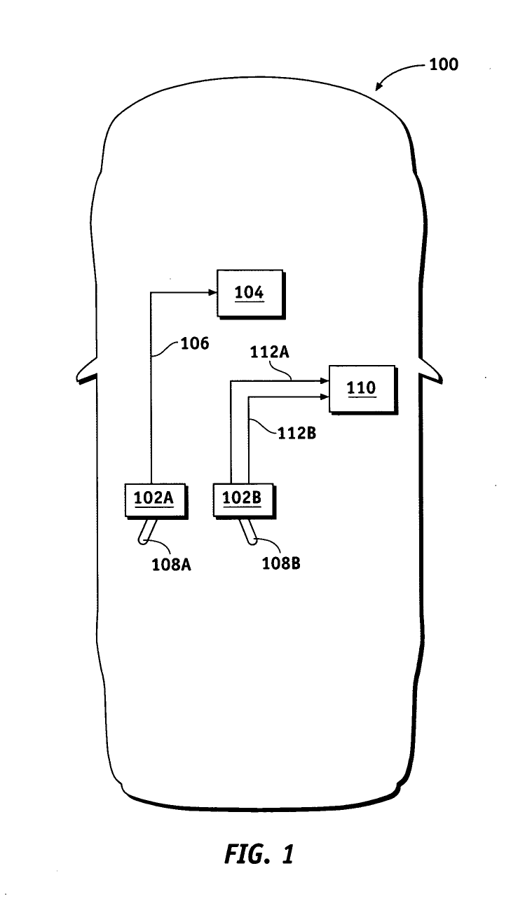

Turning now to the drawing figures and with initial reference to FIG. 1, an exemplary vehicle 100 suitably includes any number of components 104, 110 communicating with various switches 102A, 102B to receive control signals 106, 112A-B, respectively. The various components 104, 110 may represent any electric or electronic devices present within vehicle 100, including, without limitation, 2WD/4WD transfer case controls, windshield or other window controls, driver/passenger seat controls, power mirror selection and actuation devices, power take off selection/actuation devices, joysticks, multi-position selectors, digital controllers coupled to such devices and/or any other electrical systems, components or devices within vehicle 100.

Switches 102A-B are any devices capable of providing various logic signals 106, 112A-B to components 104, 110 in response to user commands, sensor readings or other input stimuli. In an exemplary embodiment, switches 102A-B respond to displacement or activation of a lever 108A-B or other actuator as appropriate. Various switches 102A-B may be formulated with electrical, electronic and/or mechanical actuators to produce appropriate ternary output signals onto one or more wires or other electrical conductors joining switches 102 and components 104, 110, as described more fully below. These ternary signals may be processed by components 104, 110 to place the components into desired states as appropriate. In various embodiments, a single ternary signal 106 may be provided (e.g. between switch 102A and component 104 in FIG. 1), and/or multiple signals 112A-B may be provided (e.g. between switch 102B and component 110 in FIG. 1), with logic in component 104 (or an associated controller) combining or otherwise processing the various signals 112A-B to extract meaningful instructions. In still further embodiments, binary, ternary and/or other signals may be combined in any suitable manner to create any number of switchable states.

Many types of actuator or stick-based control devices provide several output signals 112A-B that can be processed to determine the state of a single actuator 108B. Lever 108B may correspond to the actuator in a 2WD/4WD selector, electronic mirror control, power take off selector or any other device operating within one or more degrees of freedom. In alternate embodiments, lever 108A-B moves in a ball-and-socket or other arrangement that allows multiple directions of movement. The concepts described herein may be readily adapted to operate with any type of mechanical selector, including any type of lever, stick, or other actuator that moves with respect to the vehicle via any slidable, rotatable or other coupling (e.g. hinge, slider, ball-and-socket, universal joint, etc.).

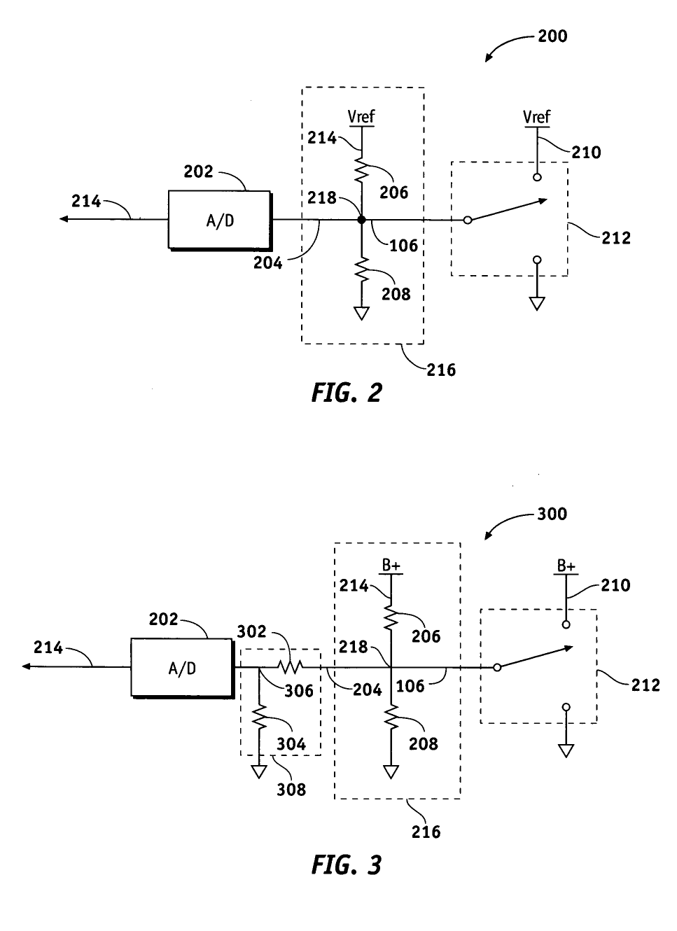

Referring now to FIG. 2, an exemplary switching circuit 200 suitably includes switch contacts 212, a voltage divider circuit 216 and an analog-to-digital (A/D) converter 202. Switch contacts 212 suitably produce a three-state output signal that is appropriately transmitted across conductor 106 and decoded at voltage divider circuit 216 and/or A/D converter 202. The circuit 200 shown in FIG. 2 may be particularly useful for embodiments wherein a common reference voltage (V_{ref}) for A/D converter 202 is available to switch contacts 212 and voltage divider circuit 216, although circuit 200 may be suited to array of alternate environments as well.

Switch contacts 212 are any devices, circuits or components capable of producing a binary, ternary or other appropriate output on conductor 106. In various embodiments, switch contacts 212 are implemented with a conventional double-throw switch as may be commonly found in many vehicles. Alternatively, contacts 212 are implemented with a multi-position operator or other voltage selector as appropriate. Contacts 212 may be implemented with a conventional three-position low-current switch, for example, as are commonly found on many vehicles. Various of these switches optionally include a spring member (not shown) or other mechanism to bias an actuator 106 (FIG. 1) into a default position, although bias mechanisms are not found in all embodiments. Switch contacts 212 conceptually correspond to the various switches 102A-B shown in FIG. 1.

Switch contacts 212 generally provide an output signal selected from two reference voltages (such as a high reference voltage (e.g. V_{ref}) and a low reference voltage (e.g. ground)), as well as an intermediate value. In an exemplary embodiment, V_{ref} is the same reference voltage provided to digital circuitry in vehicle 100 (FIG. 1), and may be the same reference voltage provided to A/D converter 202. In various embodiments, V_{ref} is on the order of five volts or so, although other embodiments may use widely varying reference voltages. The intermediate value provided by contacts 212 may correspond to an open circuit (e.g. connected to neither reference voltage), or may reflect any intermediate value between the upper and lower reference voltages. An intermediate open circuit may be desirable for many applications, since an open circuit will not typically draw a parasitic current on signal line 106 when the switch is in the intermediate state, as described more fully below. Additionally, the open circuit state is relatively easily implemented using conventional low-current three-position switch contacts 212.

Contacts 212 are therefore operable to provide a ternary signal 106 selected from the two reference signals (e.g. V_{ref} and ground in the example of FIG. 2) and an intermediate state. This signal 106 is provided to decoder circuitry in one or more vehicle components (e.g. components 104, 110 in FIG. 1) as appropriate. In various embodiments, the three-state switch contact 212 is simply a multi-position device that merely selects between the two reference voltages (e.g. power and ground) and an open circuit position or other intermediate condition. The contact is not required to provide any voltage division, and consequently does not require electrical resistors, capacitors or other signal processing components other than simple selection apparatus. In various embodiments, switch 212 optionally includes a mechanical interlocking capability such that only one state (e.g. power, ground, intermediate) can be selected at any given time.

The signals 106 produced by contacts 212 are received at a voltage divider circuit 216 or the like at component 104, 110 (FIG. 1). As shown in FIG. 2, an exemplary voltage divider circuit 216 suitably includes a first resistor 206 and a second resistor 208 coupled to the same high and low reference signals provided to contacts 212, respectively. These resistors 206, 208 are joined at a common node 218, which also receives the ternary signal 106 from switch 212 as appropriate. In the exemplary embodiment shown in FIG. 2, resistor 206 is shown connected to the upper reference voltage V_{ref} 214 while resistor 208 is connected to ground. Resistors 206 and 208 therefore function as pull-down and pull-up resistors, respectively, when signals 106 correspond to ground and V_{ref.} While the values of resistors 206, 208 vary from embodiment to embodiment, the values may be selected to be approximately equal to each other such that the common node is pulled to a voltage of approximately half the V_{ref} voltage when an open circuit is created by contact 212. Hence, three distinct voltage signals (i.e. ground, V_{ref}/2, V_{ref}) may be provided at common node 218, as appropriate. Alternatively, the magnitude of the intermediate voltage may be adjusted by selecting the respective values of resistors 206, 208 accordingly. In various embodiments, resistors 206, 208 are both selected as having a resistance on the order of about 1-50 kOhms, for example about 10 kOhms, although any other values could be used in a wide array of alternate embodiments. Relatively high resistance values may assist in conserving power and heat by reducing the amount of current flowing from V_{ref} to ground, although alternate embodiments may use different values for resistors 206, 208.

The ternary voltages present at common node 208 are then provided to an analog-to-digital converter 202 to decode and process the signals 204 as appropriate. In various embodiments, A/D converter 202 is associated with a processor, controller, decoder, remote input/output box or the like. Alternatively, A/D converter 202 may be a comparator circuit, pipelined A/D circuit or other conversion circuit capable of providing digital representations 214 of the analog signals 204 received. In an exemplary embodiment, A/D converter 202 recognizes the high and low reference voltages, and assumes intermediate values relate to the intermediate state. In embodiments wherein V_{ref} is equal to about five volts, for example, A/D converter may recognize voltages below about one volt as a “low” voltage, voltages above about four volts as a “high” voltage, and voltages between one and four volts as intermediate voltages. The particular tolerances and values processed by A/D converter 202 may vary in other embodiments.

As described above, then, ternary signals 106 may be produced by contacts 212, transmitted across a single carrier, and decoded by A/D converter 202 in conjunction with voltage divider circuit 216. Intermediate signals that do not correspond to the traditional “high” or “low” outputs of contact 212 are scaled by voltage divider circuit 216 to produce a known intermediate voltage that can be sensed and processed by A/D converter 202 as appropriate. In this manner, conventional switch contacts 212 and electrical conduits may be used to transmit ternary signals in place of (or in addition to) binary signals, thereby increasing the amount of information that can be transported over a single conductor. This concept may be exploited across a wide range of automotive and other applications.

Referring now to FIG. 3, an alternate embodiment of a switching circuit 300 suitably includes an additional voltage divider 308 in addition to contact 212, divider circuit 216 and A/D converter 202 described above in conjunction with FIG. 2. The circuit shown in FIG. 3 may provide additional benefit when one or more reference voltages (e.g. V_{ref}) provided to A/D converter 202 are unavailable or inconvenient to provide to contact 212. In this case, another convenient reference voltage (e.g. a vehicle battery voltage B⁺, a run/crank signal, or the like) may be provided to contact 212 and/or voltage divider circuit 216 as shown. Using the concepts described above, this arrangement provides three distinct voltages (e.g. ground, B⁺/2 and B⁺) at common node 204. These voltages may be out-of-scale with those expected by conventional A/D circuitry 202, however, as exemplary vehicle battery voltages may be on the order of twelve volts or so. Accordingly, the voltages present at common node 204 are scaled with a second voltage divider 308 to provide input signals 306 that are within the range of sensitivity for A/D converter 202.

In an exemplary embodiment, voltage divider 308 includes two or more resistors 302 and 304 electrically arranged between common node 208 and the input 306 to A/D converter 202. In FIG. 3, resistor 302 is shown between nodes 208 and 306, with resistor 304 shown between node 306 and ground. Various alternate divider circuits 308 could be formulated, however, using simple application of Ohm's law. Similarly, the values of resistors 302 and 304 may be designed to any value based upon the desired scaling of voltages between nodes 218 and 306, although designing the two resistors to be approximately equal in value may provide improved signal-to-noise ratio for circuit 300.

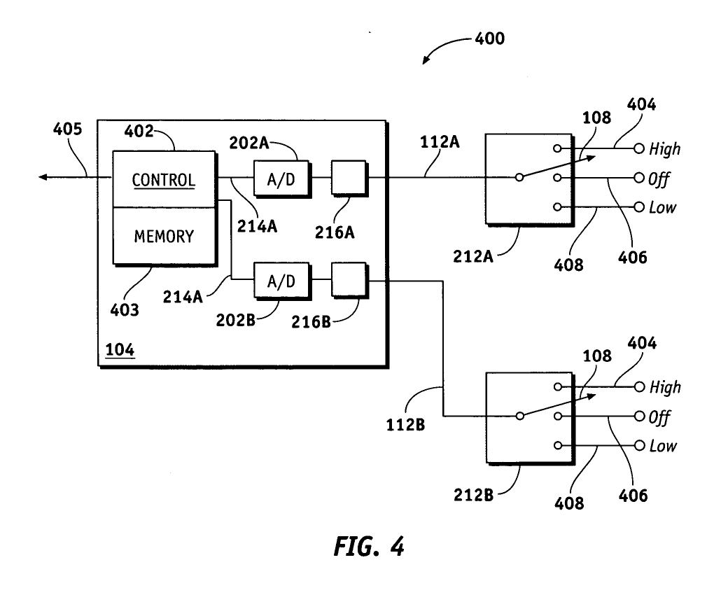

Using the concepts set forth above, a wide range of control circuits and control applications may be formulated, particularly within automotive and other vehicular settings. As mentioned above, the binary and/or ternary signals 106 produced by contacts 212 may be used to provide control data to any number of vehicle components 104, 110 (FIG. 1). With reference now to FIG. 4, the various positions 404, 406, 408 of contacts 212A-B may be appropriately mapped to various states, conditions or inputs 405 provided to component 104. As described above, component 104 suitably includes (or at least communicates with) a processor or other controller 402 that includes or communicates with A/D converter 202 and voltage divider circuit 210 to receive ternary signals 112A-B from contacts 212. The digital signals 214 produced by A/D converter 202 are processed by controller 402 as appropriate to respond to the three-state input received at contacts 212. Accordingly, mapping between states 404, 406 and 408 is typically processed by controller 402, although alternate embodiments may include signal processing in additional or alternate portions of system 400. Signals 214 received from contacts 212 may be processed in any appropriate manner, and in a further embodiment may be stored in a digital memory 403 as appropriate. Although shown as separate components in FIG. 4, memory 403 and processor 402 may be logically and/or physically integrated in any manner. Alternatively, memory 403 and processor 402 may simply communicate via a bus or other communications link as appropriate.

Although FIG. 4 shows an exemplary embodiment wherein controller 402 communicates with two switches 212A-B, alternate embodiments may use any number of switches 212, as described more fully below. The various outputs 214A-B of the switching circuits may be combined or otherwise processed by controller 402, by separate processing logic, or in any other manner, to arrive at suitable commands provided to device 104. The commands resulting from this processing may be used to place device 104 into a desired state, for example, or to otherwise adjust the performance or status of the device. In various embodiments, a desired state of device 104 is determined by comparing the various input signals 214A-B received from contacts 212A-B (respectively). The state of device 104, then, can be determined by the collective states of the various input signals 214A-B.

As used herein, input state 404 is arbitrarily referred to as ‘1’ or ‘high’ and corresponds to a short circuit to V_{ref}, B⁺ or another high reference voltage. Similarly, input state 408 is arbitrarily referred to as ‘0’ or ‘low’, and corresponds to a short circuit to ground or another appropriate low reference voltage. Intermediate input state 406 is arbitrarily described as ‘value’ or ‘v’, and may correspond to an open circuit or other intermediate condition of switch 212. Although these designations are applied herein for consistency and ease of understanding, the ternary states may be equivalently described using other identifiers such as “0”, “1” and “2”, “A”, “B” and “C”, or in any other convenient manner. The naming and signal conventions used herein may therefore be modified in any manner across a wide array of equivalent embodiments.

In many embodiments, intermediate state 406 of contacts 212 is most desirable for use as a “power off” state of device 104, since the open circuit causes little or no current to flow from contacts 212, thereby conserving electrical power. Moreover, an ‘open circuit’ fault is typically more likely to occur than a faulty short to either reference voltage; the most likely fault (e.g. open circuit) conditions may therefore be used to represent the least disruptive states of device 104 to preserve robustness. Short circuit conditions, for example, may be used to represent an “OFF” state of device 104. In such systems, false shorts would result in turning device 104 off rather than improperly leaving device 104 in an “ON” state. On the other hand, some safety-related features (e.g. headlights) may be configured to remain active in the event of a fault, if appropriate. Accordingly, the various states of contacts 212 described herein may be re-assigned in any manner to represent the various inputs and/or operating states of component 104 as appropriate.

Using the concepts of ternary switching, various exemplary mappings of contacts 212 for certain automotive and other applications may be defined as set forth below. The concepts described above may be readily implemented to create a multi-state control hat could be used, for example, to control a power takeoff, powertrain component, climate or audio component, other mechanical and/or electrical component, and/or any other automotive or other device. In such embodiments, two or more switches 102/202 are generally arranged proximate to an actuator 108, with the outputs of the switches corresponding to the various states/positions of the actuator.

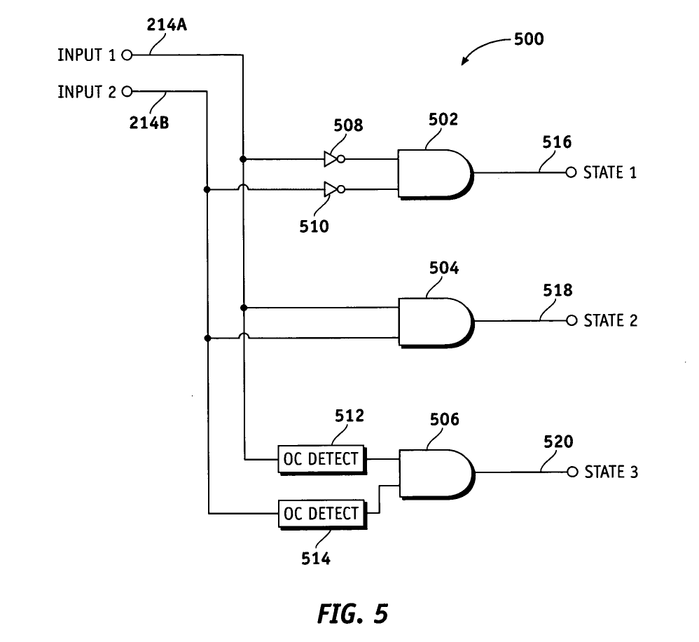

In various embodiments, the outputs of the switches may be processed using conventional software logic, logic gates (e.g. AND/NAND, OR/NOR or the like) and/or processing circuitry to determine the state of the actuator. Turning to FIG. 5, for example, a conceptual logic diagram 500 for decoding the desired state of device 104 suitably includes any number of processing gates 502, 504, 506, 508, 510, 512, 514 as appropriate. Each of these gates may be implemented in any manner. In various embodiments, each of the gates are implemented with software instructions residing within memory 403 (FIG. 4) and executed by controller 402. Alternatively, decoding logic 500 may be implemented using discrete, integrated or other components, or with any other combination of hardware and/or software. [0036] In the exemplary embodiment shown in FIG. 5, a first detected state 516 represents both input signals 214A and 214B being logically “low”, corresponding to contacts 212A-B each being coupled to the “low” reference voltage (e.g. electrical ground). This state is shown detected with two conventional digital logic inverters 508, 510 and with a conventional digital AND gate 502. Similarly, the second detected state 518 represents both input signals 214A and 214B being logically “high”, corresponding to contacts 212A-B each being coupled to the “high” reference voltage (e.g. a battery voltage). The third detected state 520 represents both input signals 214A and 214B being in the intermediate state (e.g. “value” or “v”), corresponding to both contacts 212A-B being in the open circuit or other intermediate position. This intermediate state can be detected with conventional circuitry 512, 514 as appropriate. Although each of the detected states 516, 518, 520 happen to be represented in FIG. 5 with both input signals 214A-B being in the same state, such a limitation is not found in all embodiments, as described more fully below. By varying the arrangement of logical operators within decoder 500, any combination of input signals 214A-B can be mapped to any number of output states 516, 518, 520.

The various mappings and arrangements of input signals used to represent the states of device 104 may be assigned in any manner. In various embodiments, however, certain combinations of input signals may provide various benefits such as reduced electrical current consumption, improved safety, or the like. Accordingly, by choosing the particular combinations of input signals used to represent the various operating states of device 104, control system 400 can be designed for improved performance.

By associating the “default” state for device 104 with one or more “open circuit” positions of contacts 212, for example, the amount of current consumed when the device is in the default position may be suitably reduced, since little or no current flows through the contact 212 when the contact is in the intermediate “open circuit” state. Because very little current flows while the switch is in this state, current consumption is minimized in the default state of device 104.

Further, using the assumption that open circuits are more likely to be encountered than shorts to ground, which in turn are more likely than shorts to the battery voltage (B⁺), the various device states can be mapped to the inputs such that least-desired state is associated with the input conditions that are least likely to occur accidentally. Using the previous assumptions and the exemplary embodiment shown in FIG. 5, for example, an “ON” state for a device 104 may correspond to both input contacts 212A-B being coupled to the “high” reference voltage, an “OFF” state could correspond to both contacts being coupled to the “low” reference voltage, and the default/operating/“no change” state may correspond to both contacts 212 being in the intermediate “open circuit” state. This arrangement reduces current consumption during the default state and makes accidental engagement of the controlled device 104 less likely than accidental disengagement. Although the “OFF”, “ON” and “DEFAULT” states of device 104 could theoretically be represented by a single set of three-state switch contacts 212, the additional input provides redundancy that improves the safety or “robustness” of the system.

The control system 400 may be made even more robust by selecting the operating state conditions to increase the number of signal transitions used to alter the operating state of device 104. By increasing the number of signal transitions required to switch device 104 between two different states, the likelihood of an accidental state transition caused by a faulty switch is significantly reduced, thereby making the system more robust. If each state change requires at least two signal transitions, for example, the system is insulated against accidental state changes caused by a single broken wire, faulty contact 212 or the like. This concept can be exploited to improve the robustness of the control system 400.

Generally speaking, two ternary switches are capable of representing nine distinct states, as shown in TABLE 1 below:

TABLE 1

| State | Input1 | Input2 |
|---|---|---|
| 1 | 0 | 0 |
| 2 | 0 | v |
| 3 | 0 | 1 |
| 4 | v | 0 |
| 5 | v | v |
| 6 | v | 1 |
| 7 | 1 | 0 |
| 8 | 1 | v |
| 9 | 1 | 1 |

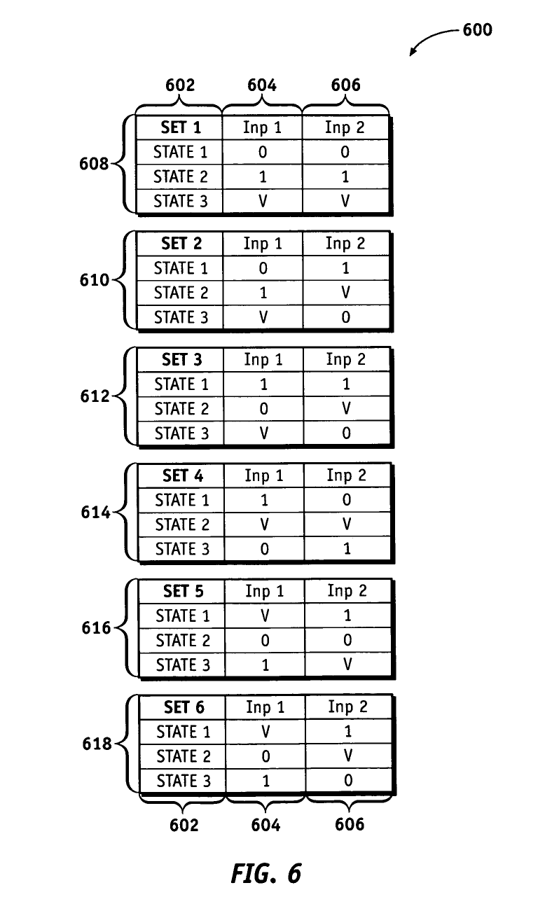

In embodiments wherein only three operating states of device 104 need to be represented, however, the three sets of inputs used to represent the three operating states may be chosen to improve the robustness of system 400. That is, the sets may be chosen such that any transition from one state to another involves at least two signal transitions. From the nine possible states shown in TABLE 1, six different sets of states will provide complete robustness (i.e. each input signal changes to produce a state change in device 104). These “robust state sets” are shown in FIG. 6.

Referring now to FIG. 6, six sets 608, 610, 612, 614, 616 and 618 of state mappings are shown. Each state within the set is represented by a particular value of an input signal. Set 608 (“Set1” in FIG. 6), for example, generally corresponds to the decoder scenario discussed in conjunction with FIG. 5 above. Each set 608, 610, 612, 614, 616 and 618 is shown with a state identifier 602, a value 604 for first input signal 112A, and a value 606 for the second input signal 112B. As seen in the figure, each of the states in each set is completely signal-independent of the other states within that set. That is, each input signal 604, 606 transitions from one value to another to produce a transition from any state in the set to any other state. Even if one signal 604 or 606 were to inadvertently transition to another state, then, device 104 would not change state, since each state transition necessitates a signal transition for each input. The unused states in each set could therefore be optionally used as diagnostic or fault states, with occurrences of the unused states indicating a short, open circuit or other malfunction.

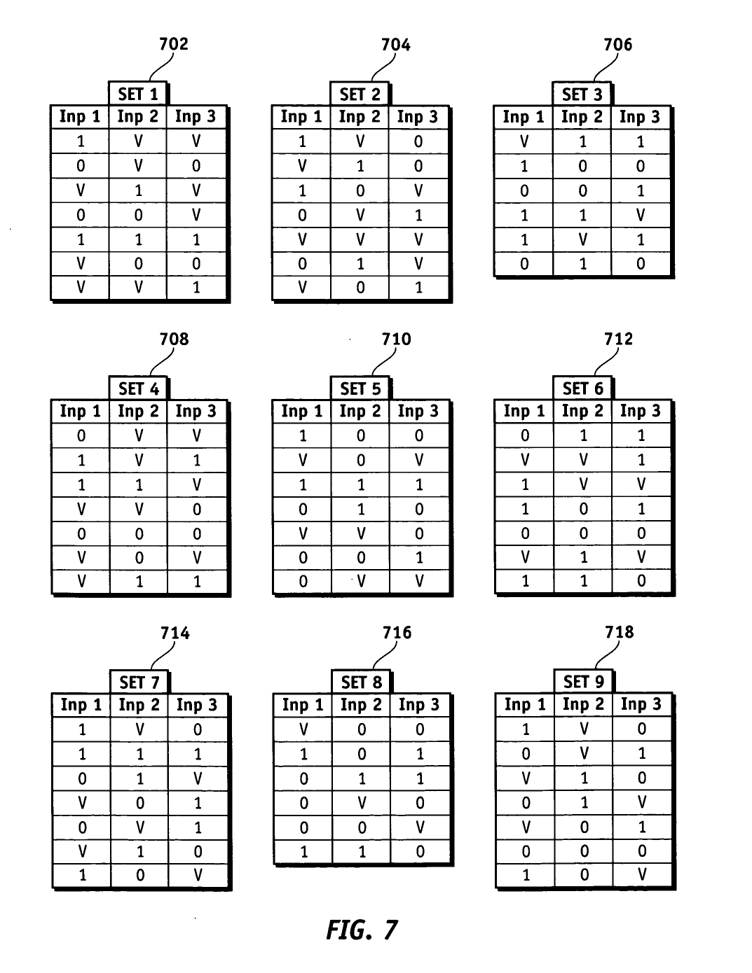

Similar concepts may be applied in control systems having more than two inputs. Three ternary inputs, for example, could be used to represent as many as seven robust states using any of the input signal combination sets shown in FIG. 7. With reference now to FIG. 7, various sets 702, 704, 708, 710, 712, 714 and 718 are capable of representing seven unique states in a robust manner, and sets 706 and 716 are capable of representing six unique states in a robust manner. Although three ternary signals are capable of representing twenty-seven separate states, only seven states may generally be assigned with two-transition robustness. As seen in each of the sets in FIG. 7, at least two input signals must change state to produce a state change in the controlled device 104. Set 704, for example, includes a state wherein all three inputs are in the intermediate “V” state that is well-suited for use as a default state as described above. Transitions from the default state in set 704 to any other state can only result from at least two input signals transitioning from the “V” state to the “0” or “1” state. Similar concepts can be applied to each of the various sets shown in FIG. 7.

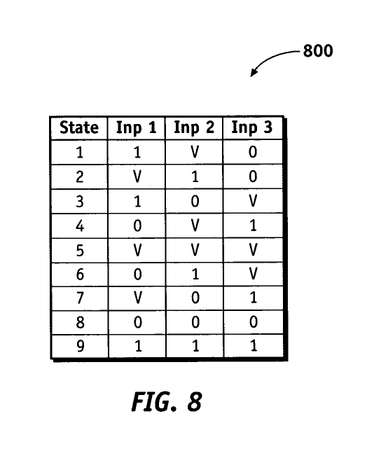

With momentary reference to FIG. 8, table 800 shows a set of states similar to set 704 in FIG. 7, but with two additional states corresponding to each input signal having a value of “0” or “1”. This arrangement represents a canonical form of the three-state inputs that effectively provides nine robust states. Table 800 (like table 608 in FIG. 6) may not provide the level of independence between states that is provided by other tables shown in FIGS. 6 and 7 due to each signal in states 8 and 9 having a common reliance upon a low or high reference voltage (respectively). If the reference voltage should become unavailable due to a fault or other undesirable condition, for example, each of the signals tied to that reference could appear as open circuits, thereby creating confusion between states 8 or 9 and state 5. Nevertheless, if the states in table 800 are properly assigned (e.g. with state 5 as a default state), the effects of this condition can be mitigated, and a nine-state table 800 can be provided.

The general concepts described herein could be modified in many different ways to implement a diverse array of equivalent multi-state switches, actuators and other controls. Controls having fewer states than those shown in FIGS. 6-7 could be readily formed without sacrificing robustness by simply omitting one or more of the states shown. The various three-state sets shown in FIG. 6, for example, could be used to create any number of two-state controls by simply choosing two of the three available states to represent the two states (e.g. “ON”, “OFF”) of the controlled device 104. Further, the various positions of actuator 108 may be extracted and decoded through any type of processing logic, including any combination of discrete components, integrated circuitry and/or software. Moreover, the various positional and switching structures shown in the figures and tables contained herein may be modified and/or supplemented in any manner. Still further, the concepts presented herein may be applied to any number of ternary and/or discrete switches, or any combination of ternary and discrete switches to create any number of potential or actual robust and non-robust state representations. Similar concepts to those described above could be applied to four or more input signals, for example, allowing for control systems capable of processing any number of robust states in a wide array of equivalent embodiments.

Although the various embodiments are most frequently described with respect to automotive applications, the invention is not so limited. Indeed, the concepts, circuits and structures described herein could be readily applied in any commercial, home, industrial, consumer electronics or other setting. Ternary switches and concepts could be used to implement a conventional joystick, for example, or any other pointing/directing device based upon four or more directions. The concepts described herein could therefore be readily applied in aeronautical, aerospace, marine or other vehicular settings as well as in the automotive context.

While at least one exemplary embodiment has been presented in the foregoing detailed description, a vast number of variations exist. The various circuits described herein may be modified through conventional electrical and electronic principles, for example, or may be logically altered in any number of equivalent embodiments without departing from the concepts described herein. The exemplary embodiments described herein are intended only as examples, and are not intended to limit the scope, applicability, or configuration of the invention in any way. Rather, the foregoing detailed description will provide those skilled in the art with a convenient road map for implementing one or more exemplary embodiments. Various changes can therefore be made in the functions and arrangements of elements set forth herein without departing from the scope of the invention as set forth in the appended claims and the legal equivalents thereof.

What is claimed is:

1. A robust control system for placing a controlled device into a desired operating state in response to a position of a multi-position actuator, the system comprising:
a first switch coupled to the multi-position actuator and configured to provide a first ternary input value (Input1) as a function of the state of the multi-position actuator;
a second switch coupled to the multi-position actuator and configured to provide a second ternary input value (Input2) as a function of the state of the multi-position actuator; and
control logic configured to receive the first and second inputs and to determine the desired state for the controlled device based upon the first and second inputs received, wherein the desired operating state is determined from a plurality of operating states described at least in part by the first and second ternary input values, and wherein each of the plurality of operating states are selected such that transitions between any of the plurality of operating states require changes in each of the first and second ternary input values.

2. The circuit of claim 1 wherein the first and second ternary signals are selected from a first reference value (“0”), a second reference value (“1”) and an intermediate state (“v”).

3. The circuit of claim 2 wherein the intermediate state corresponds to an open circuit.

4. The circuit of claim 2 wherein the control logic determines the desired state of the multi-position actuator according to the following table:

| State | Input1 | Input2 |
|---|---|---|
| 1 | 0 | 0 |
| 2 | v | v |
| 3 | 1 | 1 |

5. The circuit of claim 4 wherein state 2 corresponds to the default state of the multi-position actuator.

6. The circuit of claim 2 wherein the control logic determines the state of the multi-position actuator according to the following table:

| State | Input1 | Input2 |
|---|---|---|
| 1 | 0 | 1 |
| 2 | 1 | v |
| 3 | v | 0 |

7. The circuit of claim 2 wherein the control logic determines the state of the multi-position actuator according to the following table:

| State | Input1 | Input2 |
|---|---|---|
| 1 | 1 | 1 |
| 2 | 0 | v |
| 3 | v | 0 |

8. The circuit of claim 2 wherein the control logic determines the state of the multi-position actuator according to the following table:

| State | Input1 | Input2 |
|---|---|---|
| 1 | 1 | 0 |
| 2 | v | v |
| 3 | 0 | 1 |

9. The circuit of claim 8 wherein state 2 corresponds to the default state of the multi-position actuator.

10. The circuit of claim 2 wherein the control logic determines the state of the multi-position actuator according to the following table:

| State | Input1 | Input2 |
|---|---|---|
| 1 | v | 1 |
| 2 | 0 | 0 |
| 3 | 1 | v |

11. The circuit of claim 2 wherein the control logic determines the state of the multi-position actuator according to the following table:

| State | Input1 | Input2 |
|---|---|---|
| 1 | v | 1 |
| 2 | 0 | v |
| 3 | 1 | 0 |

12. The circuit of claim 2 further comprising a third switch coupled to the multi-position actuator and configured to provide a third ternary input value (Input3) as a function of the state of the multi-position actuator, and wherein the control logic is further configured to determine the desired operating state from the first, second and third ternary input values.

13. The circuit of claim 12 wherein the control logic determines the state of the multi-position actuator according to the following table:

| State | Input1 | Input2 | Input3 |
|---|---|---|---|
| 1 | 1 | v | v |
| 2 | 0 | v | 0 |
| 3 | v | 1 | v |
| 4 | 0 | 0 | v |
| 5 | 1 | 1 | 1 |
| 6 | v | 0 | 0 |
| 7 | v | v | 1 |

14. The circuit of claim 12 wherein the control logic determines the state of the multi-position actuator according to the following table:

| State | Input1 | Input2 | Input3 |
|---|---|---|---|
| 1 | 1 | v | 0 |
| 2 | v | 1 | 0 |
| 3 | 1 | 0 | v |
| 4 | 0 | v | 1 |
| 5 | v | v | v |
| 6 | 0 | 1 | v |
| 7 | v | 0 | 1 |

15. The circuit of claim 14 wherein state 5 corresponds to the default state of the multi-position actuator.

16. The circuit of claim 12 wherein the control logic determines the state of the multi-position actuator according to the following table:

| State | Input1 | Input2 | Input3 |
|---|---|---|---|
| 1 | V | 1 | 1 |
| 2 | 1 | 0 | 0 |
| 3 | 0 | 0 | 1 |
| 4 | 1 | 1 | V |
| 5 | 1 | V | 1 |
| 6 | 0 | 1 | 0 |

17. The circuit of claim 12 wherein the control logic determines the state of the multi-position actuator according to the following table:

| State | Input1 | Input2 | Input3 |
|---|---|---|---|
| 1 | 0 | v | v |
| 2 | 1 | v | 1 |
| 3 | 1 | 1 | v |
| 4 | v | v | 0 |
| 5 | 0 | 0 | 0 |
| 6 | v | 0 | v |
| 7 | V | 1 | 1 |

18. The circuit of claim 12 wherein the control logic determines the state of the multi-position actuator according to the following table:

| State | Input1 | Input2 | Input3 |
|---|---|---|---|
| 1 | 1 | 0 | v |
| 2 | v | 0 | v |
| 3 | 1 | 1 | 1 |
| 4 | 0 | 1 | 0 |
| 5 | v | v | 0 |
| 6 | 0 | 0 | 1 |
| 7 | 0 | v | v |

19. The circuit of claim 12 wherein the control logic determines the state of the multi-position actuator according to the following table:

| State | Input1 | Input2 | Input3 |
|---|---|---|---|
| 1 | 0 | 1 | 1 |
| 2 | v | v | 1 |
| 3 | 1 | v | v |
| 4 | 1 | 0 | 1 |
| 5 | 0 | 0 | 0 |
| 6 | v | 1 | v |
| 7 | 1 | 1 | 0 |

20. The circuit of claim 12 wherein the control logic determines the state of the multi-position actuator according to the following table:

| State | Input1 | Input2 | Input3 |
|---|---|---|---|
| 1 | 1 | v | 0 |
| 2 | 1 | 1 | 1 |
| 3 | 0 | 1 | v |
| 4 | v | 0 | 1 |
| 5 | 0 | v | 1 |
| 6 | v | 1 | 0 |
| 7 | 1 | 0 | v |

21. The circuit of claim 12 wherein the control logic determines the state of the multi-position actuator according to the following table:

| State | Input1 | Input2 | Input3 |
|---|---|---|---|
| 1 | v | 0 | 0 |
| 2 | 1 | 0 | 1 |
| 3 | 0 | 1 | 1 |
| 4 | 0 | V | 0 |
| 5 | 0 | 0 | V |
| 6 | 1 | 1 | 0 |

22. The circuit of claim 12 wherein the control logic determines the state of the multi-position actuator according to the following table:

| State | Input1 | Input2 | Input3 |
|---|---|---|---|
| 1 | 1 | v | 0 |
| 2 | 0 | v | 1 |
| 3 | v | 1 | 0 |
| 4 | 0 | 1 | v |
| 5 | v | 0 | 1 |
| 6 | 0 | 0 | 0 |
| 7 | 1 | 0 | v |

23. The circuit of claim 12 wherein the control logic determines the state of the multi-position actuator according to the following table:

| State | Input1 | Input2 | Input3 |
|---|---|---|---|
| 1 | 1 | v | 0 |
| 2 | v | 1 | 0 |
| 3 | 1 | 0 | v |
| 4 | 0 | v | 1 |
| 5 | v | v | v |
| 6 | 0 | 1 | v |
| 7 | v | 0 | 1 |
| 8 | 0 | 0 | 0 |
| 9 | 1 | 1 | 1 |

24. The circuit of claim 23 wherein state 5 corresponds to the default state of the multi-position actuator.

25. A method of selecting a desired state in a controlled device in response to the position of a multi-position actuator, the method comprising the steps of:
receiving a plurality of ternary input signals from the multi-position actuator;
decoding the plurality of ternary input signals to determine the desired state of the controlled device from a plurality of operating states, wherein each of the plurality of operating states is described by the first and second ternary input values, and wherein each of the plurality of operating states is selected such that transitions between any of the plurality of operating states require changes in at least two of the ternary input signals; and
transmitting a signal to the controlled device to place the controlled device into the desired state.

26. The method of claim 25 wherein each of the plurality of ternary signals are selected from a first reference value (“0”), a second reference value (“1”) and an intermediate state (“v”).

27. The method of claim 26 wherein the decoding step comprises determining the desired state of the multi-position actuator according to the following table:

| State | Input1 | Input2 |
|---|---|---|
| 1 | 0 | 0 |
| 2 | v | v |
| 3 | 1 | 1 |

28. The method of claim 27 wherein state 2 corresponds to the default state of the multi-position actuator.

29. The method of claim 26 wherein the decoding step comprises determining the desired state of the multi-position actuator according to the following table:

| State | Input1 | Input2 |
|---|---|---|
| 1 | 1 | 0 |
| 2 | v | v |
| 3 | 0 | 1 |

30. The method of claim 29 wherein state 2 corresponds to the default state of the multi-position actuator.

31. The method of claim 26 wherein the decoding step comprises determining the desired state of the multi-position actuator according to the following table:

| State | Input1 | Input2 | Input3 |
|---|---|---|---|
| 1 | 1 | v | 0 |
| 2 | v | 1 | 0 |
| 3 | 1 | 0 | v |
| 4 | 0 | v | 1 |
| 5 | v | v | v |
| 6 | 0 | 1 | v |
| 7 | v | 0 | 1 |

32. The method of claim 31 wherein state 5 corresponds to the default state of the multi-position actuator.

33. The method of claim 26 wherein the decoding step comprises determining the desired state of the multi-position actuator according to the following table:

| State | Input1 | Input2 | Input3 |
|---|---|---|---|
| 1 | 1 | v | 0 |
| 2 | v | 1 | 0 |
| 3 | 1 | 0 | v |
| 4 | 0 | v | 1 |
| 5 | v | v | v |
| 6 | 0 | 1 | v |
| 7 | v | 0 | 1 |
| 8 | 0 | 0 | 0 |
| 9 | 1 | 1 | 1 |

34. The method of claim 33 wherein state 5 corresponds to the default state of the multi-position actuator.
